(19) United States
(12) Patent Application Publication
(10) Pub. No.: US 2008/0172750 A1
(43) Pub. Date: Jul. 17, 2008

(54) SELF VALIDATION OF USER AUTHENTICATION REQUESTS

(76) Inventors: Craig J. Keithley, San Jose, CA (US); Richard Murphy, Boulder Creek, CA (US)

Correspondence Address: FISH & RICHARDSON P.C., PO BOX 1022, MINNEAPOLIS, MN, 55440-1022, US

(21) Appl. No.: 11/623,726

(22) Filed: Jan. 16, 2007

(51) Int. Cl. G06F 21/22; H04N 7/167

(52) U.S. Cl. 726/28; 380/200

(57) ABSTRACT

Systems, methods, and apparatus, including computer program products, for security are provided. In some implementations, a method is provided. The method includes receiving a request to access a secured feature and retrieving one or more media objects associated with a particular user. The method also includes presenting the media object to the user in a page presented to the user, including presenting a request for user authentication to access the secured feature.

### BACKGROUND

The present disclosure relates to security systems.

Conventional computing systems typically include access controls for particular features associated with the system. For example, authentication can be required to logon to a computing system or to access particular resources. Different access control schemes can be used. For example, a conventional authentication scheme can include presenting a challenge to a user of a computing system. The challenge requests information only authorized users should know, for example, a password. Other access control schemes can include a request for a physical item that only authorized users should possess, for example, a smartcard or biometric data such as a fingerprint or retinal scan.

In another access control scheme, a set of keystrokes are used to present an authentication display. For example, pressing control, alt, and delete keys simultaneously can result in the generation of a logon authentication display. Webpage spoofing, also known as phishing, techniques can include replicating a user interface to present a false authentication display to a user, which appears to be valid. The user therefore can unknowingly provide authentication data, which can then be used (e.g., by a third party, malicious software) for malicious purposes.

### SUMMARY

Systems, methods, and apparatus, including computer program products, for security are provided. In general, in one aspect, a method is provided. The method includes receiving a request to access a secured feature and retrieving one or more media objects associated with a particular user. The method also includes presenting the media object to the user in a page presented to the user, including presenting a request for user authentication to access the secured feature.

Implementations of the method can include one or more of the following features. The method can further include receiving a user selection of the media object and associating the media object with the user. The method can further include storing the media object in a secure location and encrypting the media object prior to storage. The method can further include decrypting the media object prior to presenting the media object to the user. The method can further include receiving a user selection of presentation data associated with the selected media object. The presentation data can include a location on the page for displaying the media object. The presentation data can include one or more effects associated with the display of the media object. The presentation data can include an animation associated with the display of the media object.

The method can further include initially assigning a random media object to the user, authenticating the user, and receiving a user selection of a new media object to be associated with the user. Retrieving a media object can include accessing a secure storage location and decrypting the media object. The method can further include receiving a user selection of additional media objects to be associated with the user. The method can further include preventing copying of the media object when presented to the user. The method can further include receiving authentication data from the user authenticating the user, and allowing access to the secured feature. The presented media object can be an image or video. Receiving a request to access a secured feature can include receiving a logon request. Receiving a request to access a secure feature can include receiving a request to access administrator features.

In general, in one aspect, a method is provided. The method includes receiving a request to access a secured feature, retrieving one or more media objects associated with a particular user, and presenting the media object to the user in a page presented to the user, including presenting an access control request to access the secured feature.

In general, in one aspect, a method is provided. The method includes receiving a request for service, retrieving one or more media objects associated by the requestor with the service or the requester, and presenting the one or more media objects to the requester when verifying access to the service.

In general, in one aspect, a method is provided. The method includes processing a request for access. Processing the request for access includes retrieving one or more media objects associated by a requester with the access and presenting the one or more media objects to the requester along with an access control request.

In general, in one aspect, a method is provided. The method includes receiving a request to access a secured feature, retrieving one or more media objects associated with the secured feature, and presenting the media object to the user in a page presented to the user, including presenting an access control request to access the secured feature.

In general, in another aspect, a computer program product is provided. The computer program product is operable to cause data processing apparatus to perform operations including receiving a request to access a secured feature, retrieving one or more media objects associated with a particular user, and presenting the media object to the user in a page presented to the user, including presenting a request for user authentication to access the secured feature.

In general, in one aspect, a system is provided. The system includes a user interface device and one or more computers operable to interact with the user interface device and to receive a request to access a secured feature, retrieve one or more media objects associated with a particular user, and present the media object to the user in a page presented to the user, including presenting a request for user authentication to access the secured feature.

In general, in one aspect, a system is provided. The system includes means for receiving a request to access a secured feature, means for retrieving a media object associated with a particular user, and means for presenting the media object to the user in a page presented to the user, including presenting a request for user authentication to access the secured feature.

Particular embodiments of the invention can be implemented to realize one or more of the following advantages. A user can quickly identify a valid authentication request. The user can provide a personalized media object for use in providing more secure authentication. The personalized media object allows the user to more easily recognize their media object when presented in a valid authentication display. Additionally, presenting a media object with the authentication request provides a simple technique for user authentication, without a need for additional hardware, while preventing attacks by malicious software. The user can be quickly alerted to an attempt to present a copied media object as part of an invalid authentication request, for example, by a “void” watermark or alternate image being presented to the user.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is an exemplary block diagram of an access control system.

FIG. 2 shows an example process for selecting and storing a media object.

FIG. 3 shows an example process for designating access control.

FIG. 4 shows an example process for access control using a media object.

FIG. 5 shows an example authentication display.

Like reference numbers and designations in the various drawings indicate like elements.

### DETAILED DESCRIPTION

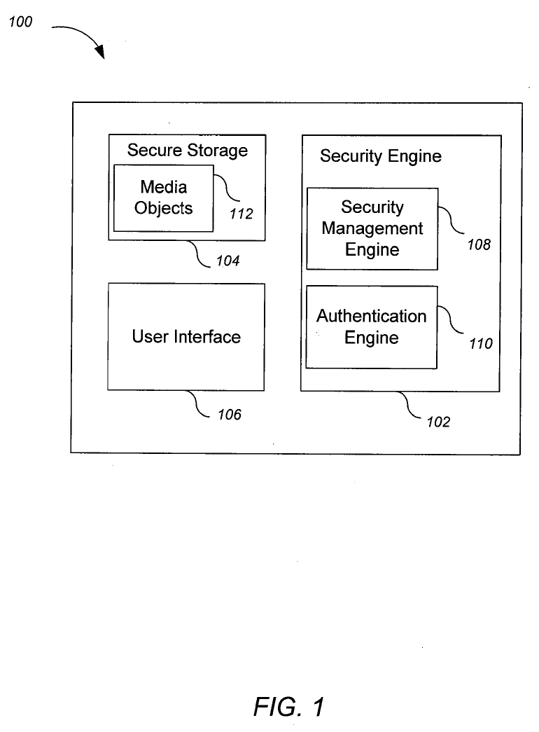

FIG. 1 is an exemplary block diagram of an access control system 100. Access control system 100 includes security engine 102, secure storage 104, and user interface 106.

The security engine 102 includes a security management engine 108 and an authentication engine 110. The security management engine 108 manages security including authentication processes. In one implementation, the security management engine 108 can determine when an authentication is triggered. Authentication refers to the verification of user credentials for the purpose of allowing access to resources. Authentication can be triggered according to a set of one or more authentication rules. The authentication rules can define particular actions or resources that require user account authentication in order to proceed. Examples of authentication rules include requiring authentication to logon to a computer system (e.g., at startup or when logging into a particular account), requiring authentication to access particular files (e.g., system files), or requiring authentication to make changes to particular system settings or preferences. The rules can be predefined or user defined (e.g., by a user with administrator privileges). For example, an administrative user can create a rule requiring authentication to access network settings or to install new software.

The security management engine 108 can also process media objects 112 (e.g., images, video clips, graphics objects, etc.) required for use in an authentication process. In one implementation, each media object 112 includes one or more images (individual images or a collection, for example, in a slideshow), video clips, graphic objects or the like. The security management engine 108 can manage storage for the media objects associated with each user account. Additionally, the security management engine 108 can retrieve one or more appropriate media objects for a particular user account when an authentication process is initiated, as will be discussed in greater detail below.

The authentication engine 110 can perform authentication functions. For example, the authentication engine can receive authentication data from a user and compare the authentication data with valid account data to determine whether or not the authentication is successful (e.g., compare a user input password with a stored account password).

Secure storage 104 can provide storage for data such that it is inaccessible to, for example, unauthorized or malicious users or programs. Secure storage 104 can also include one or more of the media objects 112. In one implementation, the secure storage 104 encrypts the data and the media objects 112 for storage. Thus, even if a given media object 112 is accessed by a malicious or unauthorized program, the (encrypted) media object 112 cannot be used for unintended purposes (e.g., phishing).

The user interface 106 generates an authentication display for the user. The authentication display can include one or more media objects associated with the user as well as one or more fields for user input of authentication data (e.g., a password). In one implementation, the authentication display is generated by the user interface 106 using information received from the security engine 102 when an authentication has been triggered.

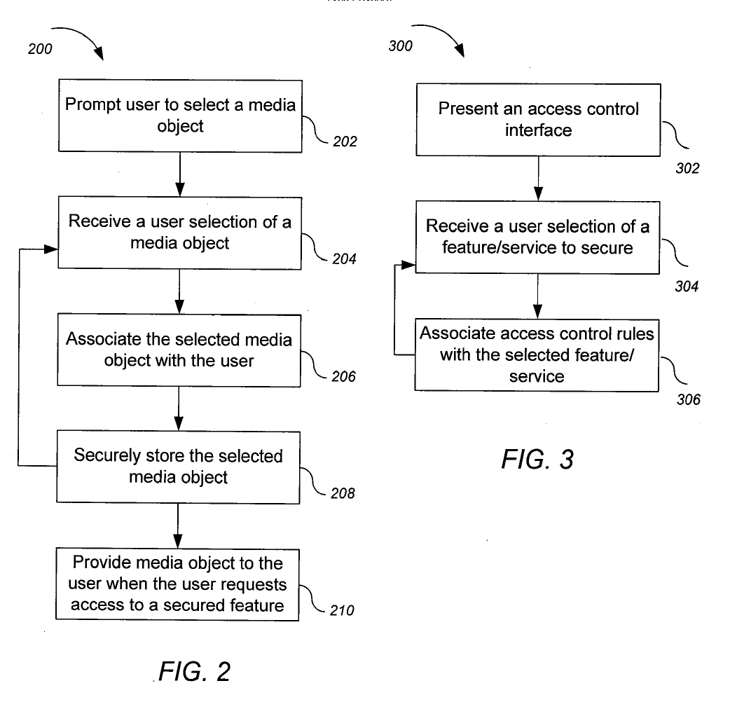

FIG. 2 shows an example process 200 for selecting and storing a media object for use in an access control process. For convenience, the processes will be described with reference to a computer system that performs the process. Other uses are possible, including uses in other types of systems. For example, the access control system and methods proposed can be used in computing systems, wireless systems, mobile systems, gaming systems, and portable electronic devices including cellular telephones, personal digital assistances, messaging devices, and the like. In one implementation, the user can select one or more media objects to be associated with the user and which are displayed when an authentication process is initiated. The computer system prompts the user to select one or more media objects (e.g., by security engine 102 using user interface 106) (step 202). In one implementation, the user is prompted to select a media object from a predefined collection of media objects. In an alternative implementation, the user can browse for any supported media object (e.g., a media object having an acceptable file type and/or size). Thus, the user is not limited to a set of media objects provided, for example, by the security engine. Instead, the user can provide one or more media objects of the user's choosing.

The user's selection is received (step 204). In one implementation, the user selects from a collection of available media objects provided by the security engine. In another implementation, the user selects a media object browsed from a file system. In an alternative implementation, the user can select (and download as required) a particular media object from an external source. For example, the user can select a personal image downloaded from a digital camera or other source.

In an alternative implementation, the system automatically selects an initial media object (e.g., at the time the user's account was created), thereby providing a default media object for presentation at the time for authentication. As part of a set-up process, a user can provide authentication data including a personalized media object which will replace the default selection.

The system associates the selected media object with the user account (step 206). Associating the selected media object with a particular user allows the media object to be presented to the user each time an access request is made (e.g., each time an access request to access a secure feature, service, or access is provided).

Optionally, the system can securely store the selected media object (step 208). In one implementation, the system stores the selected media object in a secure memory location that is inaccessible to the user directly. For example, the stored data can be inaccessible without root privileges (e.g., requires a user account with administrator access privileges). The inaccessibility of the media object prevents an unauthorized or malicious program from identifying, or capturing, the media object for use in a phishing attempt or other unauthorized or malicious activity. In another implementation, the selected media object is encrypted (e.g., by the security engine) prior to storage. For example, the media object selected by the user can be encrypted using the user's password. Consequently, even if the content is accessed by an administrative user managing the user account, the administrative user will not be able to examine the encrypted content.

Alternatively, only the association of a selected media object and a user may be protected. That is, the media objects themselves can be unsecured and only association data (e.g., derived in the selection process described above) that describes the association of one or more particular media objects with the user can be securely stored. The process steps can be repeated for each media object selected. The system can present the stored media objects associated with the user account each time the user requests access (e.g., to a secured feature requiring authentication) (step 210).

In one implementation, along with the selection of one or more media objects, the user can as well control other aspects of the display associated with the selected media objects. For example, presentation data associated with a media object can defined by the user and includes location (e.g., the location on the display where the media element will be displayed), effect(s), style, animation, and so on. In one implementation, the user selects the location of the effect, a sequence of media objects to be presented, animations between presentations, and effects (e.g., flashing effect). Other combination of user selected configurations or default configurations are possible.

In another implementation, the user can select one or more different media objects to be associated with different access control processes. For example, the user can select a particular media object to be associated with a request for access to the computer system and a different media object to be associated with a request for a particular feature. Alternatively, the user can select different aspects, such as presentation data, displayed for different access control requests. In another implementation, different default media objects can be associated with different access control processes (e.g., a video for login authentication and a static image for preferences authentication).

FIG. 3 shows an example process 300 for designating access control. In one implementation, the user (e.g., an administrator) can designate particular features including applications and files as secure. In another implementation, the user can designate services or access itself (e.g., a logon or unlock request) as secure. In one implementation, the user is presented with an access control interface (step 302). The access control interface allows the user to select a particular feature, service, or access to be secured. For example, the user can browse a list of features that can be secured. The system receives a user selection of a feature, service, or access to secure (step 304). Access control rules are then associated with the selected feature, service, or access (step 306). For example, the access control rules can designate which user accounts require authentication to proceed with a selected feature, service, or access. For example, a particular secured feature can be secured with respect to particular user accounts but not to others. The process steps can be repeated for each feature, service, or access selected.

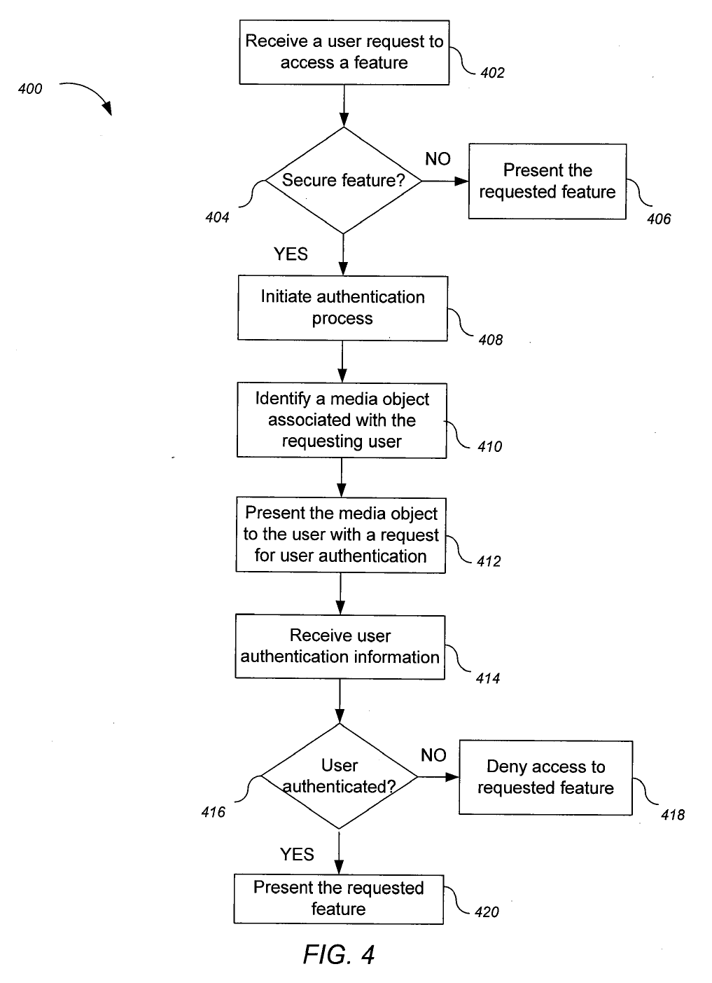

FIG. 4 shows an example process 400 for access control using a media object. The system receives a user request (e.g., received by the security engine) to access a feature, a service, or simply access associated with the computer system (step 402). The feature can include an application, a file or folder, or system settings. A request for access can include, for example a logon request. For convenience, the remaining process steps are disclosed with respect to requesting a feature, however, the process can apply to requests for services or access. A determination is made as to whether the requested feature is a secure feature (step 404). If the request is not for a secure feature, the requested feature is presented (step 406). For example, a request to access a feature that is not a secure feature can include a request to access a word processing document. The word processing document if unsecured is presented to the user without requiring, for example, user authentication (e.g., the document is opened by a word processing application).

If, however, the requested feature associated with the computer system is a secure feature, an access control process is initiated (step 408). Secure features can be predefined or rule defined according to user input (e.g., a user with administrative privileges). In one implementation, the secure feature is access to the computing system. For example, the user logon request can be a request to access a secure feature, namely the computer system itself. Other types of secure feature requests can include a request to access particular files such as system files, a request to change system settings or preferences, and a request to unlock or change properties of a screensaver (e.g., settings which lock the computer once the screensaver is triggered).

In another implementation, the secure feature can be an install or uninstall function as well as an encryption/decryption function. For example, the request can be an attempt to install or uninstall software or to decrypt stored encrypted data (e.g., a file).

After the access control process is initiated, the system (e.g., the security engine) identifies one or more media objects associated with the requesting user (step 410). In one implementation, the security engine includes data associating particular media objects with specific user accounts. In one implementation, the media objects were selected by the individual user as discussed with respect to FIG. 2. In another implementation, the media object is automatically assigned to particular users, for example, when a user account is created.

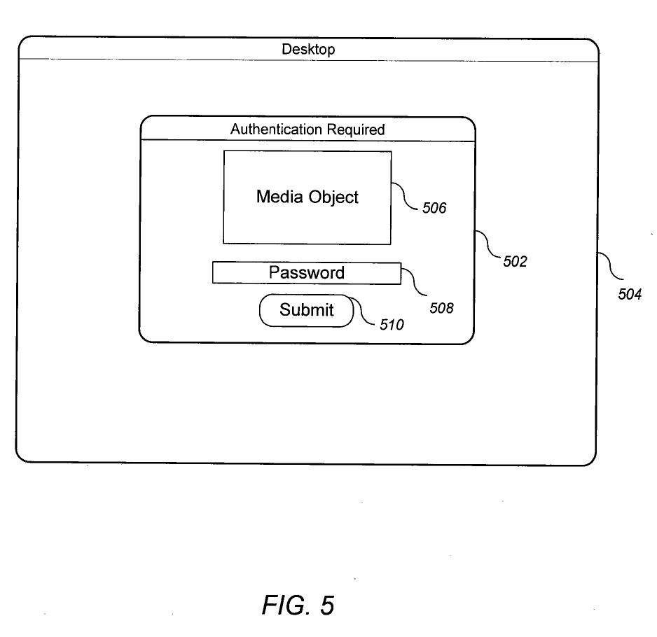

In one implementation, the access control is an authentication protocol. In this example, the system presents the one or more associated media object to the user with a request for user authentication (step 412). The associated media objects are retrieved, for example from secure storage, for presentation to the user. For example, the security engine can retrieve the media object from a secure storage location (e.g., secure storage 104). In one implementation, the media object is stored in encrypted form. The security engine can therefore first decrypt the media object and then present the media object to the user. The request for user authentication can include one or more fields for the user to input data. For example, the request for user authentication can include a password field. In one implementation, the user interface (e.g., user interface 106) presents an authentication display that includes the one or more media objects and the authentication request. An example authentication display is described below with respect to FIG. 5. In another implementation, the presented includes the one or more media objects and a request associated with another form of access control, such as a validation request.

In an alternative implementation, the user must first identify themselves prior to being presented with the associated media object(s). For example, during a logon request, the user identifies the user account seeking access (e.g., with an account username). The identified account is used to retrieve the appropriate media object. After the account is identified an authentication display is presented that includes the media object associated with the account and a password request. In another implementation, the user can identify the user account in another manner including smart card or biometric identifier (e.g., fingerprint, retinal scan).

The system receives user access control (e.g., authentication) information (step 414). In one implementation, the access control information is received by user input into a field in an authentication display. In one implementation, only a password is required. For example, if a user has already logged into a system, the user is known and only a password is needed for authentication to access particular secure features.

A determination is made as to whether or not the user has privileges (e.g., is authenticated) (step 416). The user is authenticated, for example, if the access control information provided matches stored data associated with the user account. For example, in one implementation, an authentication engine (e.g., authentication engine 110) compares the input authentication data from the user with known account information (e.g., compares the input password with a stored account password). If the access control steps (e.g., if authentication fails), the user is denied access to the requested feature (step 418). If successful, the user is presented with the requested feature (step 420). For example, the user is allowed to access system settings or to install software.

FIG. 5 shows an example authentication display 502. The authentication display 502 is presented within a graphical user interface 504 for a computing system. For example, the authentication display 502 can be a window or dialog box presented within a standard computer desktop interface.

The authentication display 502 includes one or more media objects 506, password field 508, and submit button 510. The media object 506 can be an image, a video clip, slideshow, graphics object or other media as described above. The password field 508 allows the user to type in a password associated with the user account in order to authenticate the user. In operation, the user will provide the password only if the presented media object(s) 506 are the media object(s) associated with the user's account. Thus, the user can determine the validity of the access control request prior to providing password information. In one implementation, the password field 508 is configured to hide the user's input characters. For example, the display can remain blank or present a symbol (e.g., “*”) for each input character to prevent the password from being observed. The submit button 510 is executed by the user (e.g., with a cursor) to submit the access control data, which is then checked, for example, by the authentication engine.

In one implementation, a video clip is used as a media object in order to enhance security by preventing a camera from taking an image of the authentication display in order to create a false display including the image.

In another implementation, the security engine can prevent an unauthorized or malicious program from obtaining a screen capture of the computing system with the authentication display shown (e.g., by disabling copy, clip, or screen capture capabilities of an underlying operating system or application). This prevents a phishing by presenting an actual copy of the authentication display (e.g., captured from an earlier presentation of the authentication display by a malicious program) to the user in order to obtain the user's authentication data. Alternatively, if the image is copied (e.g., with a screen capture) a watermark (e.g., “void”) or an alternative image will appear when a phishing attempt is made using the copied image.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer-readable medium for execution by, or to control the operation of, data processing apparatus. The instructions can be organized into module or engines in different numbers and different combinations from the exemplary modules described. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method comprising:
receiving a request to access a secured feature;
retrieving one or more media objects associated with a particular user; and
presenting the media object to the user in a page presented to the user, including presenting a request for user authentication to access the secured feature.

2. The method of claim 1, further comprising:
receiving a user selection of the media object; and
associating the media object with the user.

3. The method of claim 2, further comprising:
storing the media object in a secure location.

4. The method of claim 2, further comprising:
encrypting the media object prior to storage.

5. The method of claim 4, further comprising:
decrypting the media object prior to presenting the media object to the user

6. The method of claim 2, further comprising:
receiving a user selection of presentation data associated with the selected media object.

7. The method of claim 6, where the presentation data includes a location on the page for displaying the media object.

8. The method of claim 6, where the presentation data includes one or more effects associated with the display of the media object.

9. The method of claim 6, where the presentation data includes an animation associated with the display of the media object.

10. The method of claim 1, further comprising:
initially assigning a random media object to the user;
authenticating the user; and
receiving a user selection of a new media object to be associated with the user.

11. The method of claim 1, where retrieving a media object includes accessing a secure storage location.

12. The method of claim 1, where retrieving the media object includes decrypting the media object.

13. The method of claim 1, further comprising:
receiving a user selection of additional media objects to be associated with the user.

14. The method of claim 1, further comprising:
preventing copying of the media object when presented to the user.

15. The method of claim 1, further comprising:
receiving authentication data from the user;
authenticating the user; and
allowing access to the secured feature.

16. The method of claim 1, where the presented media object is an image.

17. The method of claim 1, where the presented media object is a video.

18. The method of claim 1, where receiving a request to access a secured feature includes receiving a logon request.

19. The method of claim 1, where receiving a request to access a secure feature includes receiving a request to access administrator features.

20. A method comprising:
receiving a request to access a secured feature;
retrieving one or more media objects associated with a particular user; and
presenting the media object to the user in a page presented to the user, including presenting an access control request to access the secured feature.

21. A method comprising:
receiving a request for service;
retrieving one or more media objects associated by the requester with the service or the requester; and
presenting the one or more media objects to the requestor when verifying access to the service.

22. A method comprising:
processing a request for access including:
retrieving one or more media objects associated by a requestor with the access; and
presenting the one or more media objects to the requester along with an access control request.

23. A method comprising:
receiving a request to access a secured feature;
retrieving one or more media objects associated with the secured feature; and
presenting the media object to the user in a page presented to the user, including presenting an access control request to access the secured feature.

24. A computer program product, encoded on a computer-readable medium, operable to cause data processing apparatus to perform operations comprising:
receiving a request to access a secured feature;
retrieving one or more media objects associated with a particular user; and
presenting the media object to the user in a page presented to the user, including presenting a request for user authentication to access the secured feature.

25. A system comprising:
a user interface device; and
one or more computers operable to interact with the user interface device and to:
receive a request to access a secured feature,
retrieve one or more media objects associated with a particular user, and
present the media object to the user in a page presented to the user, including presenting a request for user authentication to access the secured feature.

26. A system comprising:
means for receiving a request to access a secured feature;
means for retrieving a media object associated with a particular user;
means for presenting the media object to the user in a page presented to the user, including presenting a request for user authentication to access the secured feature.
